(19) United States
(12) Patent Application Publication
(10) Pub. No.: US 2013/0071819 A1
(43) Pub. Date: Mar. 21, 2013

(54) Gluten-free and Special Diets Rehabilitation and Living Center

(71) Applicant: Nadine Marie Grzeskowiak, Corvallis, OR (US)

(72) Inventor: Nadine Marie Grzeskowiak, Corvallis, OR (US)

(21) Appl. No.: 13/613,423

(22) Filed: Sep. 13, 2012

Related U.S. Application Data
(60) Provisional application No. 61/535,053, filed on Sep. 15, 2011.

(51) Int. Cl. G09B 19/00

(52) U.S. Cl. 434/127

(57) ABSTRACT

A gluten-free and special diets rehabilitation and living center is provided. The center consists of a cost-friendly, clean, inviting and healthy environment with caring, fun and well educated staff. The center helps residents recover from or live with special dietary needs including gluten intolerance or food allergies. Many services are offered that allow residents to carry on a normal, uninterrupted lifestyle. The center provides features that maintain a resident's connection to family such as facilitating on-site visitations, providing family living units, and providing multimedia communications with family.

### CROSS-REFERENCES TO RELATED APPLICATIONS

This application claims priority to U.S. Provisional Patent Application Ser. No. 61/535,053 filed on Sep. 15, 2011, entitled “Gluten-free and Special Diets Rehabilitation and Age-In-Place Center”, the disclosure of which is hereby incorporated by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### SEQUENCE LISTING

Not Applicable

### BACKGROUND OF THE INVENTION

1. Field of the Invention

The present invention relates to the organization and administration of care to those requiring or preferring gluten-free or other special needs diets by establishing a rehabilitation center capable of providing long-term diet management.

2. Description of the Related Art

In the spectrum of malabsorption disorders, gluten intolerance, in the form of Celiac disease, is quickly becoming the most common. When compared to blood samples from the 1950s, the disorder has presented an increase in prevalence by over four fold to one-in-fifty people afflicted, approaching the statistical relevance of lactose intolerance.

Celiac disease is also known as Gluten Sensitive Enteropathy, or Celiac Sprue. While the exact mechanism of gluten intolerance in the body is unknown, it is hypothesized that the two proteins within the gluten molecule, Gliadin and Glutelin stimulate an inappropriate T-cell mediated immune response which destroys the mucosal enterocytes lining the small intestine. Once the intestinal lining has been damaged, the absorption of nutrients decreases which can lead to malnutrition, muscular atrophy, fatigue, abdominal distension, growth retardation, iron-deficiency anemia, dental enamel hypoplasia, and osteoporosis. It is not uncommon for those with Celiac disease to also experience more severe symptoms such as dermatitis herpetiformis, ataxia, peripheral neuropathy which are congruent with the symptomology of multiple sclerosis.

Unfortunately, to date, there is no cure for Celiac disease. The only relief for those whom suffer this disease is to abstain from consuming gluten, avoiding coming into contact with gluten-based products, and to carefully monitor food preparation in order to avoid cross contamination.

Gluten and gluten-based products such as common white flour are extensively used in prepared foods as an additive, preservative, or as a filler. With commercially prepared foods becoming more commonplace in supermarkets than ever before, the challenge of maintaining a gluten-free diet is increasing in difficulty. Most commercially prepared foods will not provide a visible disclaimer to the presence of gluten within the advertised product, making food selections more-than-somewhat risky for a person uneducated in gluten-product recognition.

As an unfortunate side effect of grand-scale gluten-based food avoidance, an individual with Celiac disease must not only monitor what is being consumed, as the diet can increase consumption of simple sugars and fats, but careful consideration has to be given towards what is not being consumed, namely vitamins, minerals, and other key nutrients deemed necessary to normal human physiology. Excluding foods containing gluten can almost assuredly reduce the consumption of essential minerals such as iron, calcium, fiber, thiamin, riboflavin, niacin, and folate.

If this disorder is allowed to develop unabated within the patient, mild to severe rehabilitation services will be required to restore quality of life. In short-term care, the symptoms can be reduced, but not extirpated. Symptoms generally return soon after release as very little detoxification, counseling, or education is provided to the patient during short-term rehabilitation. There exists a need for long-term rehabilitation facilities for sufferers of Celiac disease which also provides continued support, education, and counseling relevant to the disorder.

Such rehabilitation facilities or living centers can be objectively congruent with those facilities used to provide care to the elderly, or those incapable of unassisted living.

As was the case until now, it was known that when the elderly entered an assisted living facility, the health of the individuals declined greatly. This was due to substandard healthcare, poorly regulated diets, and the hospital-like absence of independent living.

Patients that were moved into assisted living centers or communities which enabled an increase in privacy and independence, yet maintained proximal medical care, experienced an increase in happiness and quality of life. With quality of life significantly higher, medical needs decreased, and patient lifespan lengthened.

Unfortunately, there exists no rehabilitation or living center specifically structured to meet the needs of those individuals in need of special diets. This is especially problematic for sufferers of Celiac disease, as a gluten-free diet will dramatically increase life expectancy and overall health. The present invention addresses special diet and gluten-free lifestyle requirements not addressed in the related art. The present invention accomplishes this by supplementing traditional assisted-care communities with the rehabilitation, counseling, and live-in services greatly needed by those with Celiac disease and special dietary requirements.

### BRIEF SUMMARY OF THE INVENTION

It is therefore an object of the present invention to provide a gluten-free and special diets rehabilitation and living center.

It is another object of the present invention to provide a gluten-free and special diets rehabilitation and living center that offers residents medical treatment, allergy-free foods, substantial amenities, and an increased quality of life.

It is yet another object of the present invention to provide a gluten-free and special diets rehabilitation and living center with a staff trained in resident advocacy, special diets, and avoidance of cross-contamination.

It is yet another object of the present invention to provide a gluten-free and special diets rehabilitation and living center that uses green building practices.

It is yet another object of the present invention to provide a gluten-free and special diets rehabilitation and living center that facilitates family connections through features including, but not limited to, communications rooms, media rooms, and on-site visitor's accommodations.

It is yet another object of the present invention to provide a gluten-free and special diets rehabilitation and living center that facilitates community connections through features including, but not limited to, partnerships with local organizations, engaging in programs with regional schools, offering on-site classes that are open to the public, and hosting pet visitation programs.

It is yet another object of the present invention to provide a gluten-free and special diets rehabilitation and living center with on-site programs and services that enhance a resident's quality of life.

In accordance with the objects of the invention described above, one exemplary embodiment of the present invention provides a gluten-free and special diets rehabilitation and living center. The center may provide a cost-friendly, clean, inviting and healthy environment with caring, fun and well educated staff. The center could help residents recover from, or live with, special dietary needs including, but not limited to, gluten intolerance or allergies to other types of food. The center may offer many services that allow residents to carry on a normal, uninterrupted lifestyle thereby increasing their quality of life.

Other objects and advantages of the present invention will be more fully apparent from the following disclosure.

### BRIEF DESCRIPTION OF THE SEVERAL VIEWS OF THE IMAGE(S)

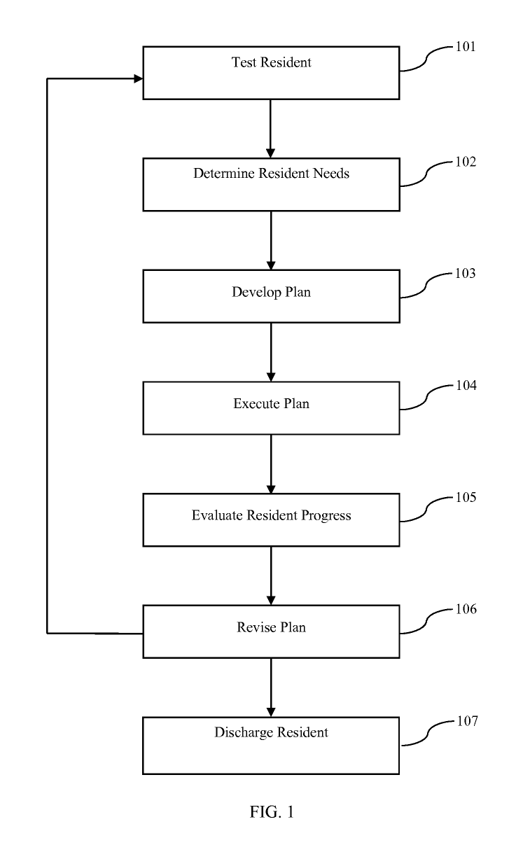

FIG. 1 is a flowchart for rehabilitating or assisting a resident with gluten-free or special diets as according to one embodiment of the present invention;

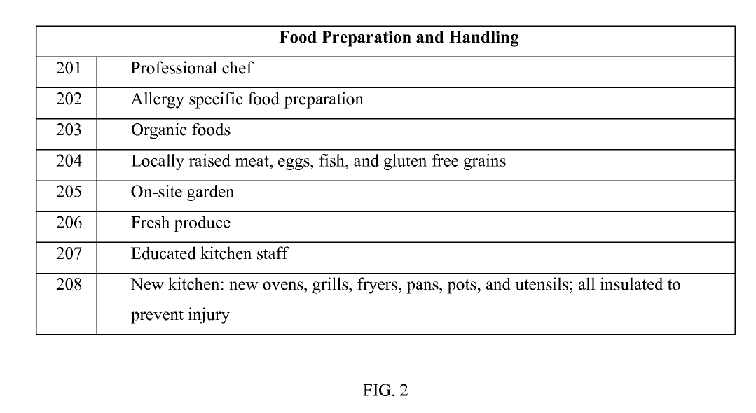

FIG. 2 is a table of food preparation and handling techniques in a gluten-free and special diets rehabilitation and living center as according to one embodiment of the present invention;

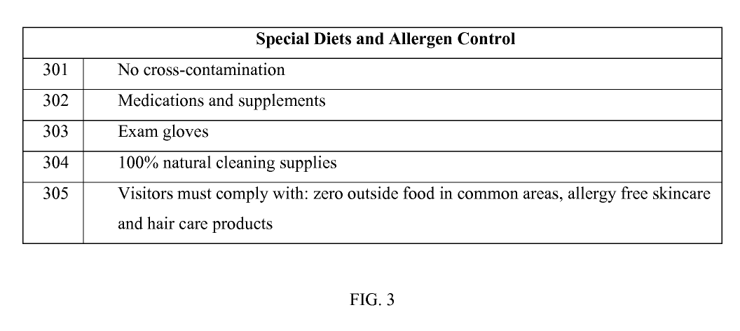

FIG. 3 is a table of special diets and allergen control methods of a gluten-free and special diets rehabilitation and living center as according to one embodiment of the present invention;

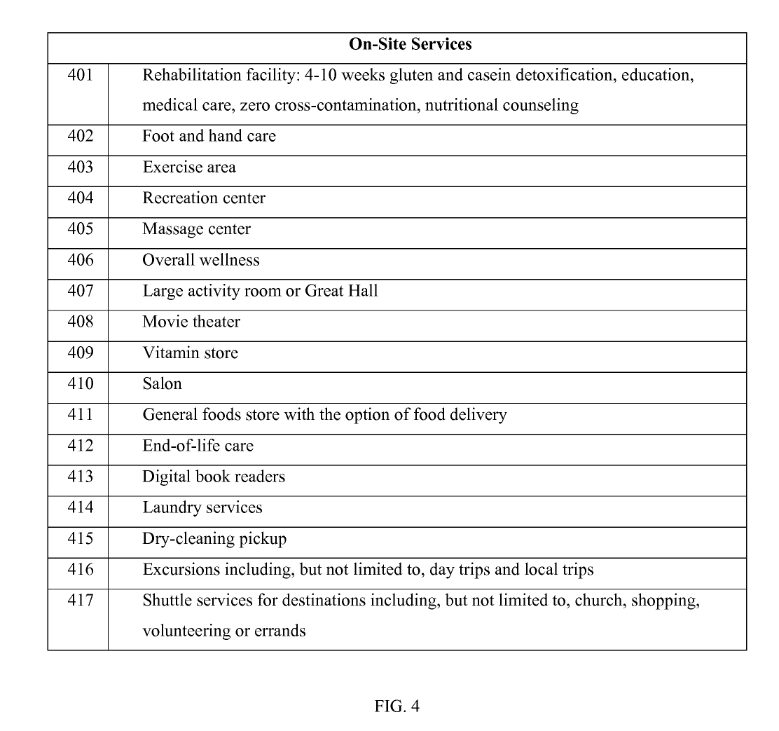

FIG. 4 is a table of on-site services in a gluten-free and special diets rehabilitation and living center as according to one embodiment of the present invention;

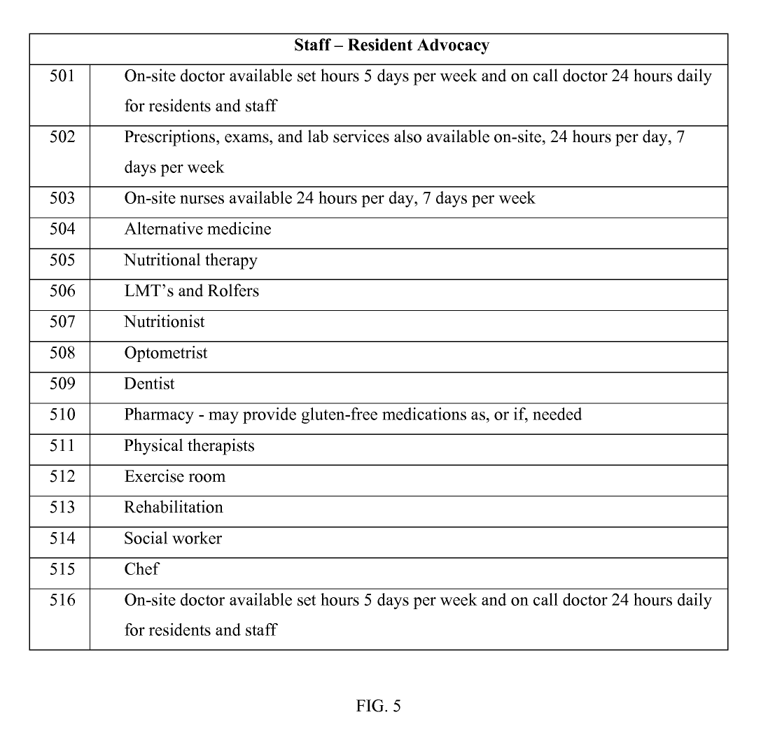

FIG. 5 is a table of staff-resident advocacy features in a gluten-free and special diets rehabilitation and living center as according to one embodiment of the present invention;

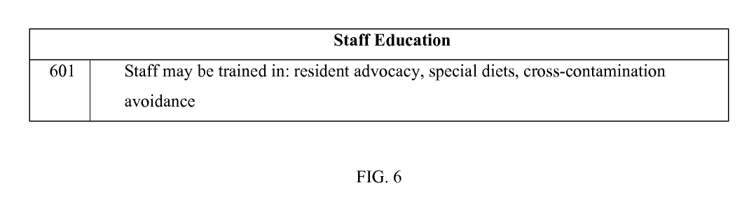

FIG. 6 is a table of staff education topics in a gluten-free and special diets rehabilitation and living center as according to one embodiment of the present invention;

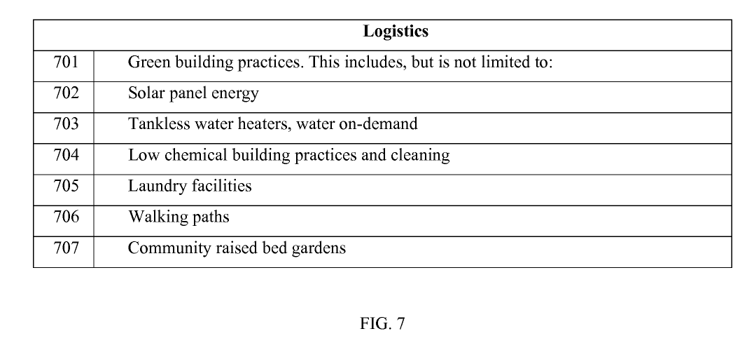

FIG. 7 is a table of logistics in a gluten-free and special diets rehabilitation and living center as according to one embodiment of the present invention;

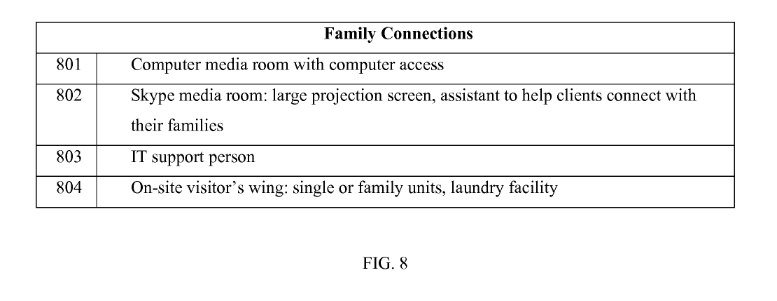

FIG. 8 is a table of family connection features in a gluten-free and special diets rehabilitation and living center as according to one embodiment of the present invention; and

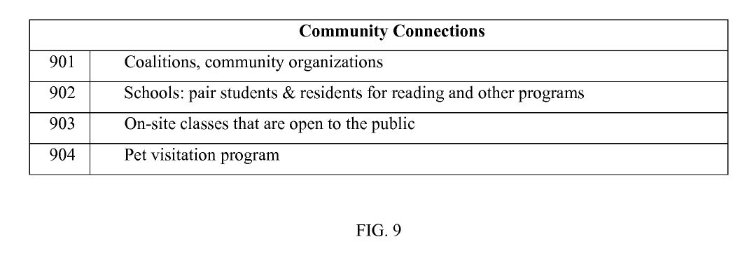

FIG. 9 is a table of community connection features in a gluten-free and special diets rehabilitation and living center as according to one embodiment of the present invention.

### DETAILED DESCRIPTION OF THE INVENTION

In the following detailed description, reference is made to specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method, system, and apparatus include the discussed feature, advantage or mode of operation. The following description of the preferred embodiment is merely exemplary in nature and is in no way intended to limit the invention, its application, or use.

Referring now to a preferred embodiment of the present invention, there is described an exemplary gluten-free and special diets rehabilitation and living center. For the purpose of clarity, the terms “gluten-free and special diets rehabilitation and living center”, “rehabilitation center”, “center”, “present invention”, and “invention” may be used interchangeably to refer to the afore-mentioned gluten-free and special diets rehabilitation and living center.

Several preferred embodiments of the center are discussed in this section. However, the present invention is not limited to these embodiments. The present invention is any gluten-free and special diets rehabilitation and living center that offers residents medical treatment, allergy-free foods, substantial amenities, and an increased quality of life. The present invention is not limited in method of operation, means for rehabilitating residents, offered services or programs, or any other feature appropriate for inclusion as part of a gluten-free and special diets rehabilitation and living center.

As set forth in this description and the attached images, a center has been developed that improves upon conventional rehabilitation and living centers. The various embodiments of the improved center described herein can be used to rehabilitate or help residents live with as wide variety of ailments. For example, certain embodiments are particularly well-adapted to assisting residents that are suffering from gluten intolerance. Other embodiments are particularly well-adapted for assisting residents that are afflicted with shellfish allergies. Still other embodiments are particularly well adapted for assisting residents that have allergic reactions to nuts such as peanuts, walnuts, or hazelnuts. Even other embodiments are particularly well adapted for assisting residents that have allergic reactions to foods containing soy products. The preceding exemplary uses are not intended to be limiting, but are merely illustrative for the possible uses of the center.

A flowchart for rehabilitating or assisting a resident with gluten-free or special diets as according to one embodiment of the present invention is illustrated in FIG. 1. The resident may first be tested (101) for malabsorption disorders or food allergies. These malabsorption disorders may include Celiac disease, also known as Celiac Sprue, which is an inflammatory response due to the ingestion gluten. The food allergies may include, but not be limited to nut allergies, shellfish allergies, and soy allergies. After a resident has been tested (101), the test results may be used to determine the resident's dietary and care needs (102). Determining what the resident needs (102) in relation to their malabsorption disorders and food allergies may allow the center's staff to establish a care plan (103) that may include recommended diets, rehabilitation procedures, and service requirements. Based on the level of severity of their disorders or allergies, residents could be provided with more or less of the center's rehabilitative services. The exact nature and description of the center's services will be discussed further in this description.

Once a resident's plan has been developed (103), the plan may be executed (104) by providing the resident with the recommended services and type of care. As part of their plan (103), the resident could be given a special diet that avoids the foods to which they are allergic or that causes their malabsorption. The plan may not be limited to only dietary changes, but could also require that a resident be offered any combination of the center's services (FIG. 4). Throughout execution of the plan (104), the resident's progress may be evaluated (105) to determine whether the plan is effective. Evaluation of a resident's progress (105) could also include re-testing the resident (101) at set intervals or at random occurrences. Depending on the resident's progress, the plan may be revised (106) to further assist the resident with their malabsorption or food allergies. Regular revision of the plan (106) may allow the center's staff to try new rehabilitation procedures in their efforts to assist the resident. If the resident displays significant improvement, the resident may eventually be discharged (107) from the center and may move back into their community. Discharge of the resident (107) may depend on a plurality of criteria including satisfactory test results (101), positive progress evaluation reports (105), sufficient education and rehabilitation (FIG. 4, 401), or any other criteria that the center deems necessary for the resident to re-enter society.

A table of food preparation and handling techniques in a gluten-free and special diets rehabilitation and living center as according to one embodiment of the present invention is shown in FIG. 2. Professional chefs (201) may be employed to prepare resident's food. Professional chefs (201) may possess the skill and expertise to meet a resident's dietary needs by providing safe and appetizing meals. Residents may be given meals that have been specifically prepared to avoid foods containing allergens (202). These foods may include, but not be limited to, organic foods (203), locally raised meat, eggs, fish, and gluten free grains (204), foods from the center's on-site garden (205), or fresh produce (206). Using the aforementioned types of foods may provide residents with food of higher nutritional quality; foods containing little or no preservative, pesticides, hormones, or antibiotics; and may guarantee that a resident's food has not come in contact with allergens. The possibility of cross-contamination (FIG. 3, 301) may be lower when the center uses organic or locally-grown foods (203, 204).

To support the professional chefs (201) and prepare food in an allergic-specific manner (202), the center may employ an educated kitchen staff (207) and may have kitchens containing new ovens, grills fryers, pans, pots, and utensils (208). All of the kitchen equipment may be insulated to prevent injury (208). The center may use new kitchens with new kitchen equipment (208) to further reduce the probability of cross-contamination (FIG. 3, 301) with allergy or malabsorption causing foods. The center may also use new kitchens and new kitchen equipment (208) to improve food preparation (202) and handling efficiency. New kitchen equipment (208) may be less likely to malfunction thereby requiring less expense and time for repair or maintenance.

A table of special diets and allergen control methods of a gluten-free and special diets rehabilitation and living center as according to one embodiment of the present invention is shown in FIG. 3. Controlling allergens may be critical to rehabilitating residents and helping them recover from malabsorption disorders or food allergies. The proper control of allergens in a resident's food and living conditions may greatly improve their quality of life and ability to re-enter society. To control allergies and prepare a resident's special diets, the center may ensure that no cross-contamination (301) occurs. Cross-contamination (301) reduction may include, but not be limited to, the proper handling of a resident's food, medication, and supplements (302). Exam gloves (303) may be used when preparing a resident's food, when interacting with the resident, or handling their belongings. The center may use 100% natural cleaning supplies (304) to ensure the resident does not come in contact with allergens or malabsorption causing materials. It may sometimes be possible for non-natural cleaning supplies to contain substances that could exacerbate a resident's condition. Visitors may be required to comply with certain protocols in order to control allergens (305). Visitors may not be allowed to bring outside food into common areas or may be asked to use allergy free skincare and hair care products (305). Visitors that have taken steps to reduce the allergens for a particular resident may inadvertently contaminate the living environment of other residents if they do not obey the center's allergen control protocols.

A table of on-site services in a gluten-free and special diets rehabilitation and living center as according to one embodiment of the present invention is shown in FIG. 4. A resident may begin rehabilitation in the center's rehabilitation facility (401). Rehabilitation may include, but not be limited to, four to ten weeks of gluten and casein detoxification, education about gluten intolerance or food allergies, medical care to help residents with their malabsorption or food allergies, no cross-contamination of gluten or other food allergens, and nutritional counseling (401). The center may also offer residents hand and foot care (402). This service is particularly important for residents also suffering from diabetes. Residents suffering from diabetes may have thickened skin, joint limitations, ulcerations, infections, or neuropathic osteoarthropathy due to their conditions.

The center may offer services designed to improve a resident's overall wellness (406). To improve overall wellness (406), it may be important for residents to remain physically active. The center may provide an exercise area (403), a recreation center (404), a massage center (405), or a large activity room or great hall (407). These features may also enable a resident to interact with other residents thereby allowing them to maintain social contacts within the center and avoid feelings of isolation or solitude. For entertainment, the center may contain a movie theater (408) or provide residents with digital book readers (413). Residents may also enjoy excursions such as day or local trips to various destinations that are organized by the center (416). On-site salons (410) may also be provided so residents could maintain personal grooming and appearances.

For residents that are unable to leave the premises, the center may provide various shopping services. These services may include, but not be limited to, laundry services (414), dry-cleaning pickup (415), general food stores with optional food delivery (411), and a vitamin store (409). For residents that are able to leave the premises, the center may offer shuttle services for residents wishing to attend church, go shopping, volunteer, run errands, or for any other purpose a resident may have for wishing to temporarily leave the center (417). Some residents may require end-of-life care (412) which may also be provided by the center. The end-of-life care (417) could include care similar to that of a hospital with spiritual care as well as physical and medical care.

A table of staff—resident advocacy features in a gluten-free and special diets rehabilitation and living center as according to one embodiment of the present invention is shown in FIG. 5. Staff and resident advocacy may be very important in order for staff or residents to access needed care. With many features being offered by the center, advocacy may serve to educate residents or to reduce the barriers that staff or residents must overcome before receiving needed care. To facilitate staff and resident advocacy, the center may have on-site doctors that are available during set hours during the week, and an on-call doctor that is available 24 hours a day, 7 days a week (501). The center may provide on-site prescription pickup, examinations, and lab services 24 hours a day, 7 days a week (502). The prescription pickup (501) may be made through an on-site pharmacy (510) that could also provide gluten-free medicines if needed. On-site nurses may be available 24 hours a day, 7 days a week. The staff and patient advocacy features may also include alternative medicines (504) for staff and residents and nutritional therapy (505Ut). The alternative medicines (504) may include holistic medicine or any other alternative medical discipline.

Specialized medical professionals may be provided by the center in an effort to further its staff-resident advocacy. These medical professionals may reduce the need for residents to leave the center and enter into the community where they may inadvertently be exposed to allergens or other harmful substances. The medical professionals may include, but not be limited to, licensed massage therapists and Rolfers (506), nutritionists (507), optometrists (508), dentists (509), physical therapists (511), social workers (514), and chefs (515). Rolfers (506) may be practitioners that physically apply a technique of manipulating the body's connective tissues in order to release stress patterns within the human form. Rolfing may lead to an improved posture and may facilitate ease of movement. An exercise room (512) may be provided for staff and residents by the center. It may be a goal of the center to provide these or any other features deemed appropriate for staff-resident advocacy in an effort to maximize the access staff and residents have to needed care.

A table of staff education topics in a gluten-free and special diets rehabilitation and living center as according to one embodiment of the present invention is shown in FIG. 6. It may be necessary for the center to educate staff so that they may provide adequate care and services to residents of the center. The staff may be trained in resident advocacy (FIG. 5), special diets, and avoidance of cross-contamination (601). The avoidance of cross-contamination may extend to a resident's food as well as their belongings, bedding, and environment. To avoid cross-contamination, special measures may be taken by the staff such as the wearing of exam gloves (FIG. 3, 303) and the use of 100% natural cleaning supplies (FIG. 3, 304).

A table of logistics in a gluten-free and special diets rehabilitation and living center as according to one embodiment of the present invention is shown in FIG. 7. The center may use logistics or building techniques that allow it lower its environmental impact, reduce costs, and improve a resident's quality of life while at the center. The center may use green building practices (701) that include, but are not limited to, the use of solar panel energy (702), tank-less or on-demand water heaters (703), and low-chemical building practices and cleaning (704). The center's logistics may also include an on-site laundry facility (705) for staff or residents. The laundry facility may operate in a manner consistent with green laundering practices, or may operate as a traditional laundry facility that does not follow green laundering practices. Green building practices may also include any other practices that reduce the overall impact of the center on the built environment, human health, and the natural environment.

The center's logistics may also include features intended to enhance a resident's quality of life. These features may include walking paths (706) that allow a resident to walk around the center for recreation or physical activity purposes. The walking paths (706) may be paved, unpaved, indoors, or outdoors, or any combination thereof. Another feature that residents may enjoy is community raised bed gardens (707). These gardens (707) may provide an area where residents or staff could grow plants, flowers, or food. The raised bed gardens could be operated and maintained solely by the residents, by the staff, or by a combination of staff and residents.

A table of family connection features in a gluten-free and special diets rehabilitation and living center as according to one embodiment of the present invention is shown in FIG. 8. Maintaining connections with family members may greatly impact a resident's well-being while staying at the center. Residents that are able to maintain close family connections may rehabilitate more quickly, may have lower levels of stress, and may feel less isolated while at the center. To facilitate family connections, the center may offer a computer room with computer access (801). The computers may allow family members to communicate via email, instant messages, VoIP, or otherwise with off-site family members. The center may also offer a Skype, or similar multimedia protocol, messaging room (802). The messaging room (802) may have a large projection screen or televisions (802) for dedicated multimedia communications. An information technology support specialist (803) may provide support to residents so that communication interruptions are reduced. The center may also support family communications by providing one or more on-site visitor's wings (804), single or family living units for residents and their families (804) and laundry facilities for visiting family members (804). The laundry facilities (804) may be the same facility as the center's primary laundry facility (FIG. 7, 705), or may be a separate facility for cross-contamination avoidance purposes.

A table of community connection features in a gluten-free and special diets rehabilitation and living center as according to one embodiment of the present invention is shown in FIG. 9. It may be important for the center to maintain close community connections to foster good relations with the community and to educate local community members. The center may wish to maintain community connections with local coalitions or other organizations (901). Maintaining connections may be accomplished through outreach programs, internships, or other educational programs organized by the community or by the center. The center may also maintain connections with local schools by pairing students and residents of the center (902). The center may offer on-site classes (903) that are open to the public. These classes may be offered for a charge or for free. The center may offer a pet visitation program (904). Residents may have a higher quality of life if they are able to spend time with their pets.

Although certain exemplary embodiments of a gluten-free and special diets rehabilitation and living center have been described herein, the scope of coverage of this patent is not limited thereto. On the contrary, this patent covers all embodiments of a gluten-free and special diets rehabilitation and living center fairly falling within the scope of the invention either literally or under the doctrine of equivalents.

With respect to the above description then, it is to be realized that the optimum configuration and relationships for the elements of the center are deemed readily apparent and obvious to one skilled in the art, and all equivalent relationships to those illustrated in the images and described in the specification are intended to be encompassed by the center.

Therefore, the foregoing is considered as illustrative only of the principles of the center. Further, since numerous modifications and changes will readily occur to those skilled in the art, it is not desired to limit the center to the exact construction and operation shown and described, and accordingly, all suitable modifications and equivalents may be resorted to, falling within the scope of the center. While the above description describes various embodiments of the present invention, it will be clear that the present invention may be otherwise easily adapted to satisfy any requirements of a gluten-free and special diets rehabilitation and living center.

As various changes could be made in the above configuration or organization without departing from the scope of the invention, it is intended that all matter contained in the above description or shown in the accompanying images shall be interpreted as illustrative and not in a limiting sense.

What is claimed is:

1. A method comprising:
providing a gluten-free or special diets rehabilitation center; providing living accommodations for residents within the gluten-free or special diets rehabilitation center;
providing staff trained to assist the residents with gluten-free or special diet needs; and
assisting residents with recovering from, or learning to live with gluten-free or special diet needs.

1. The method of claim 1, wherein the gluten-free or special diets rehabilitation center further comprises special food preparation and food handling techniques.

2. The method of claim 1, wherein the gluten-free or special diets rehabilitation center further comprises special diets and allergen control methods.

3. The method of claim 1, wherein the gluten-free or special diets rehabilitation center uses particular logistics to lower its environmental impact, reduce costs, and improve the resident's quality of life.

4. The method of claim 1, wherein the gluten-free or special diets rehabilitation center further comprises on-site services.

5. The method of claim 1, wherein the gluten-free or special diets rehabilitation center further comprises staff-resident advocacy features.

6. The method of claim 1, wherein the gluten-free or special diets rehabilitation center further comprises family connection features.

7. The method of claim 1, wherein the gluten-free or special diets rehabilitation center further comprises community connection features.

8. A system for assisting residents with gluten-free and special diet needs comprising:
A gluten-free or special diets rehabilitation center operable to provide the residents with gluten-free and special diet assistance, living accommodations, wherein the living accommodations are designed to reduce the resident's contact with gluten or other food allergies, and a staff trained to assist the residents with gluten-free or special diet needs.

9. The system of claim 8, wherein the gluten-free or special diets rehabilitation center further comprises gluten-free or special diet food preparation and handling techniques.

10. The system of claim 8, wherein the gluten-free or special diets rehabilitation center further comprises special diets and allergen control methods.

11. The system of claim 8, wherein the gluten-free or special diets rehabilitation center further comprises on-site services.

12. The system of claim 8, wherein the gluten-free or special diets rehabilitation center further comprises staff-resident advocacy features.

13. The system of claim 8, wherein the gluten-free or special diets rehabilitation center further comprises family connection features.

14. A gluten-free or special diets rehabilitation center comprising:
living accommodations for residents, the living accommodations comprising single or family units; a staff trained to assist the residents with gluten-free or special diets needs; gluten-free or allergen specific food preparation and handling techniques; and on-site services that rehabilitate or assist the residents with gluten intolerance or food-allergies.

15. The gluten-free or special diets rehabilitation center of claim 14, wherein the gluten-free or allergen-specific food preparation and handling techniques further comprise a professional chef, organic foods, locally raised food, or an on-site garden.

16. The gluten-free or special diets rehabilitation center of claim 14, wherein the gluten-free or special diets rehabilitation center further comprises no cross-contamination of gluten or food allergens.

17. The gluten-free or special diets rehabilitation center of claim 14, fur wherein the gluten-free or special diets rehabilitation center further comprises family connection features.

18. The gluten-free or special diets rehabilitation center of claim 14, wherein the on-site services includes a rehabilitation facility.

19. The gluten-free or special diets rehabilitation center of claim 14, wherein the gluten-free or special diets rehabilitation center further comprises staff-resident advocacy features.

20. The gluten-free or special diets rehabilitation center of claim 19, wherein the staff-resident advocacy features further comprises specialized medical professionals.
